(19) United States
(12) Patent Application Publication
(10) Pub. No.: US 2022/0043814 A1
(43) Pub. Date: Feb. 10, 2022

(54) INFORMATION PROCESSING DEVICE, INFORMATION PROCESSING SYSTEM, AND COMPUTER-READABLE RECORDING MEDIUM STORING INFORMATION PROCESSING PROGRAM

(71) Applicant: FUJITSU LIMITED, Kawasaki-shi (JP)

(72) Inventor: Takushi HASHIDA, Kawasaki (JP)

(73) Assignee: FUJITSU LIMITED, Kawasaki-shi (JP)

(21) Appl. No.: 17/507,838

(22) Filed: Oct. 22, 2021

Related U.S. Application Data
(63) Continuation of application No. PCT/JP2019/018648, filed on May 9, 2019.

(51) Int. Cl. G06F 16/2458

(52) U.S. Cl. CPC G06F 16/2465

(57) ABSTRACT

An information processing device includes: a memory; and a processor coupled to the memory and configured to: manage a metatask that creates new metadata, in association with a task, on the basis of metadata set to data to be processed for new data obtained by executing the task on the data to be processed; execute the metatask managed in association with the task when the task is executed on a single or a plurality of pieces of data and create new metadata on the basis of metadata set to each of the single or the plurality of pieces of data; and set the new metadata to new data obtained by executing the task on the single or the plurality of pieces of data.

### CROSS-REFERENCE TO RELATED APPLICATION

This application is a continuation application of International Application PCT/JP2019/018648 filed on May 9, 2019 and designated the U.S., the entire contents of which are incorporated herein by reference.

### FIELD

The embodiments discussed herein are related to an information processing device, an information processing system, and an information processing program.

### BACKGROUND

Typically, there is a system that executes a task on data and outputs new data. The task is processing for outputting new data by processing or calculating data. The task includes, for example, processing for aggregating demographic data in Kanto area and acquiring statistical data for 10 years or the like.

International Publication Pamphlet No. WO 2016/013099, Japanese Laid-open Patent Publication No. 2018-112848, International Publication Pamphlet No. WO 2018/061070, and Japanese Laid-open Patent Publication No. 2009-140361 are disclosed as related art.

### SUMMARY

According to an aspect of the embodiments, an information processing device includes: a memory; and a processor coupled to the memory and configured to: manage a metatask that creates new metadata, in association with a task, on the basis of metadata set to data to be processed for new data obtained by executing the task on the data to be processed; execute the metatask managed in association with the task when the task is executed on a single or a plurality of pieces of data and create new metadata on the basis of metadata set to each of the single or the plurality of pieces of data; and set the new metadata to new data obtained by executing the task on the single or the plurality of pieces of data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing device 101 according to a first embodiment;

FIG. 2 is an explanatory diagram illustrating an exemplary system configuration of an information processing system 200;

FIG. 3 is a block diagram illustrating an exemplary hardware configuration of the information processing device 101;

FIG. 4 is an explanatory diagram illustrating a specific example of data to be processed;

FIG. 5 is an explanatory diagram illustrating a specific example of metadata;

FIG. 6 is an explanatory diagram illustrating an example of storage content of a data management table 240;

FIG. 7 is an explanatory diagram illustrating an example of storage content of a task management table 260;

FIG. 8 is an explanatory diagram illustrating a specific example of a task;

FIG. 9 is an explanatory diagram (part 1) illustrating a specific example of a metatask;

FIG. 10 is an explanatory diagram (part 2) illustrating a specific example of the metatask;

FIG. 11 is a block diagram illustrating an exemplary functional configuration of the information processing device 101;

FIG. 12 is an explanatory diagram illustrating a behavior example of the information processing device 101 according to the first embodiment;

FIG. 13 is an explanatory diagram illustrating a usage example of a metatask mt1;

FIG. 14 is an explanatory diagram (part 1) illustrating a screen example of an operation screen used to select metadata of new data;

FIG. 15 is an explanatory diagram (part 2) illustrating a screen example of the operation screen used to select the metadata of the new data;

FIG. 16 is a flowchart illustrating an example of an information processing procedure of the information processing device 101 according to the first embodiment;

FIG. 17 is an explanatory diagram illustrating a behavior example of an information processing device 101 according to a second embodiment;

FIG. 18 is an explanatory diagram illustrating a usage example of a metatask mt2;

FIG. 19 is a flowchart illustrating an example of an information processing procedure of the information processing device 101 according to the second embodiment;

FIG. 20 is an explanatory diagram illustrating a behavior example of an information processing device 101 according to a third embodiment;

FIG. 21 is a flowchart illustrating an example of a first information processing procedure of the information processing device 101 according to the third embodiment; and

FIG. 22 is a flowchart illustrating an example of a second information processing procedure of the information processing device 101 according to the third embodiment.

### DESCRIPTION OF EMBODIMENTS

There is a technique, in a system for managing feature data used to create result data, that extracts processing content of a processing query used to create the result data, underlying data, and an extraction condition to extract the underlying data as the feature data of the result data. Furthermore, there is a technique, in a case where an element other than an element included in both of an item name of input data and an item name of output data is extracted and the extracted element and an argument of a program for generating the output data from the input data include an element related to an item value of the input data, for generating metadata in which the element related to the item value of the input data among the extracted element is converted into a variable.

Furthermore, there is a technique for displaying a plurality of pieces of data according to a display mode in which the plurality of pieces of data is displayed as a set of attribute information of each piece of data and determining a candidate of metadata to be added to the data displayed on the basis of the display mode. Furthermore, there is a technique for reading analysis source data, storing the read data in a data storage region, outputting a result of the analysis on the analysis source data as analysis result data, storing a location of the read analysis source data in data location information, associating the analysis result data with the analysis source data, and storing the associated data in analysis result generation source information.

In recent years, data utilization of a large amount of accumulated data through analysis processing has attracted attention. Therefore, the inventors or the like has focused on using data generated by executing one or a plurality of tasks in a series of analysis processing as a target of the data utilization. However, a mechanism for managing the data to which various processes have been executed so as to be reused has been insufficient.

In one aspect, an object of the present embodiment is to easily manage data related to task execution.

Hereinafter, embodiments of an information processing device, an information processing system, and an information processing program will be described in detail with reference to the accompanying drawings.

### First Embodiment

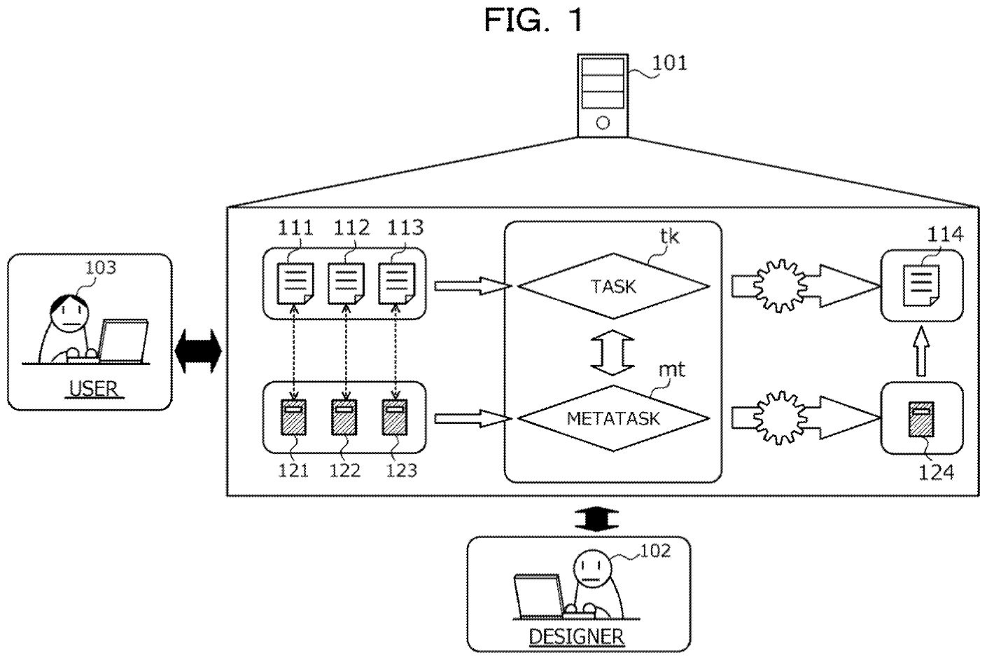

FIG. 1 is an explanatory diagram illustrating an example of an information processing device 101 according to a first embodiment. In FIG. 1, the information processing device 101 is a computer that sets metadata to data related to task execution. The task is processing for outputting new data by processing or calculating data. The data related to task execution is, for example, new data obtained by executing a task on data to be processed.

The data to be processed is a single or a plurality of pieces of data to be input to a task. The data to be processed is, for example, a comma-separated value (CSV) file, a JavaScript object Notation (JSON) file, or the like. JavaScript is a registered trademark. The metadata is an information group to explain meaning of data, set to the data.

The metadata is useful information to determine the data to be processed when the data is analyzed or the like. For example, in a system that executes a task on data and outputs new data, a user often searches for or selects data to be given to the task as relying on the metadata.

On the other hand, in a typical system, in a case where processing is executed for processing data by a task and generating new data, metadata is not added to the newly generated data. Therefore, for example, it is considered to manually confirm content of the newly generated data and add metadata.

However, it takes time and effort to manually confirm each piece of the content of the data and create the metadata. Furthermore, there is a case where some users cannot determine what type of information is added as the metadata even if the content of the data is confirmed. Furthermore, it is considered to analogize metadata from vocabulary that appears frequently in data and to add the analogized metadata. However, it is difficult to add appropriate metadata that reflects what type of processing a task executes.

Therefore, in the present embodiment, the information processing device 101 will be described that automatically sets appropriate metadata to new data obtained by executing a task. Hereinafter, a processing example of the information processing device 101 will be described.

(1) The information processing device 101 manages a metatask mt and a task tk in association with each other. Here, the metatask mt is processing for creating new metadata on the basis of metadata set to data to be processed for new data obtained by executing the task tk on the data to be processed.

The metatask mt is created by, for example, a designer 102 of the task tk. Because the designer 102 understands what type of processing is executed by the task tk, it is possible to design the metatask mt so as to create appropriate metadata that reflects processing content of the task tk.

Specifically, for example, the information processing device 101 accepts registration of the metatask mt corresponding to the task tk. When accepting the registration of the metatask mt, the information processing device 101 manages the accepted metatask mt in association with the task tk. To manage the metatask mt in association with the task tk is, for example, to manage the metatask mt so that the metatask mt can be specified from identification information of the task tk.

(2) When the information processing device 101 executes the task tk on a single or a plurality of pieces of data, the information processing device 101 executes the metatask mt that is managed in association with the task tk and creates new metadata on the basis of metadata set to each of the single or the plurality of pieces of data. The single or the plurality of pieces of data is data to be processed that is given to the task tk as an input.

In the example in FIG. 1, a user 103 issues an execution request of the task tk. At this time, the data to be processed that is given to the task tk as an input is designated. Here, a case is assumed where, as a result of executing the task tk on data to be processed 111 to 113 designated by the user 103, new data 114 is generated.

In this case, the information processing device 101 executes the metatask mt that is managed in association with the task tk and creates new metadata on the basis of metadata 121 to 123 respectively set to the data 111 to 113. Here, a case is assumed where new metadata 124 is created. Note that the task tk may be executed by another computer different from the information processing device 101.

(3) The information processing device 101 sets the created new metadata to the new data obtained by executing the task tk on the single or the plurality of pieces of data. To set the new metadata to the new data is, for example, to make it possible to specify a correspondence relationship between the new metadata and the new data.

In the example in FIG. 1, the new metadata 124 is set to the new data 114 obtained by executing the task tk on the data 111 to 113.

In this way, according to the information processing device 101, when the task tk is executed on the data to which the metadata is set, it is possible to create and set the metadata of the new data obtained by executing the task tk by the metatask mt. Furthermore, because the metatask mt can be designed while understanding what type of processing the task tk executes, it is possible to explicitly set meaning of data processing of the task tk as the metatask mt.

This makes it possible to set metadata as intended by a user to new data in synchronization with data processing and to easily manage data related to task execution, and it is possible to facilitate data utilization. Furthermore, it is possible to reduce time and effort of a user than a case where each piece of data content is manually confirmed and metadata is set.

(Exemplary System Configuration of Information Processing System 200)

Next, an exemplary system configuration of an information processing system 200 according to the first embodiment will be described. The information processing system 200 is a computer system that includes the information processing device 101 illustrated in FIG. 1 and, for example, is applied to a system that centrally manages products generated through trial and error in data processing and analysis.

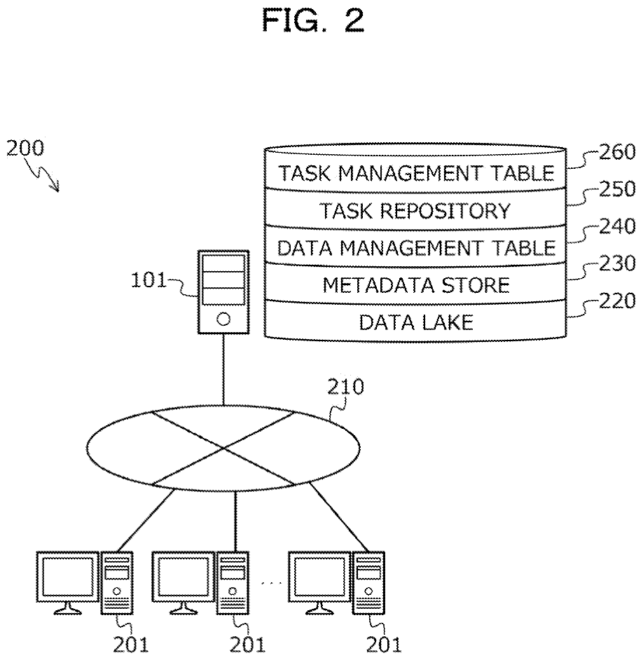

FIG. 2 is an explanatory diagram illustrating an exemplary system configuration of the information processing system 200. In FIG. 2, the information processing system 200 includes the information processing device 101 and a plurality of client devices 201. In the information processing system 200, the information processing device 101 and the plurality of client devices 201 are connected to each other via a wired or wireless network 210. The network 210 is, for example, a local area network (LAN), a wide area network (WAN), the Internet, or the like.

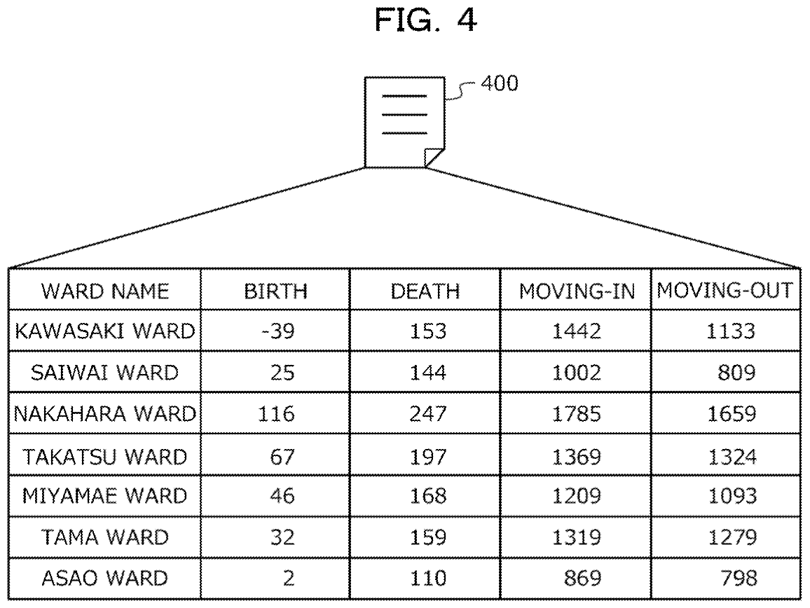

Here, the information processing device 101 includes a data lake 220, a metadata store 230, a data management table 240, a task repository 250, and a task management table 260. For example, the information processing device 101 is a server. The data lake 220 stores data to be processed. A specific example of the data to be processed will be described later with reference to FIG. 4.

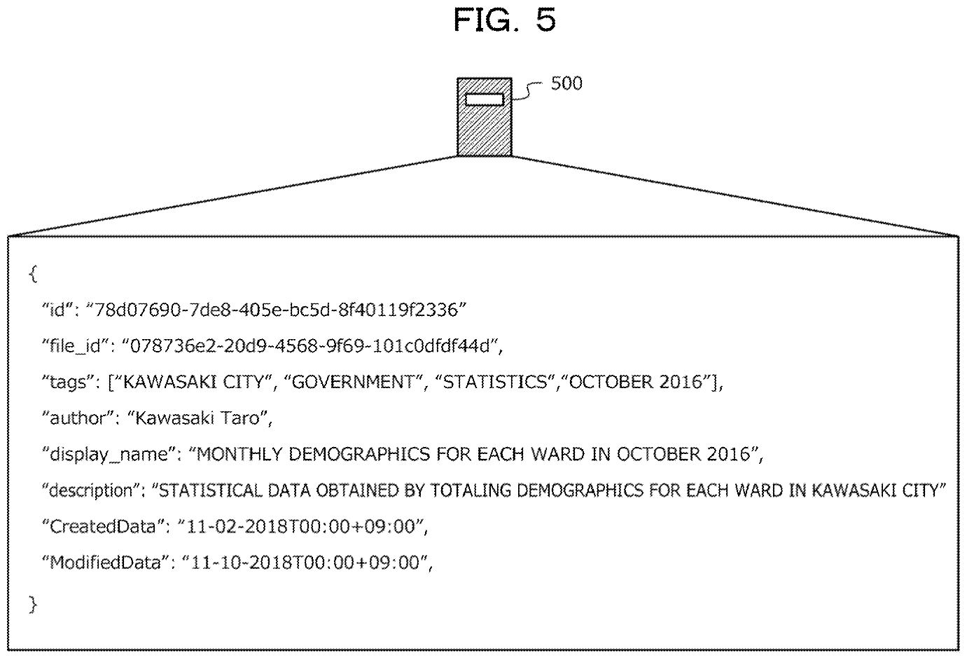

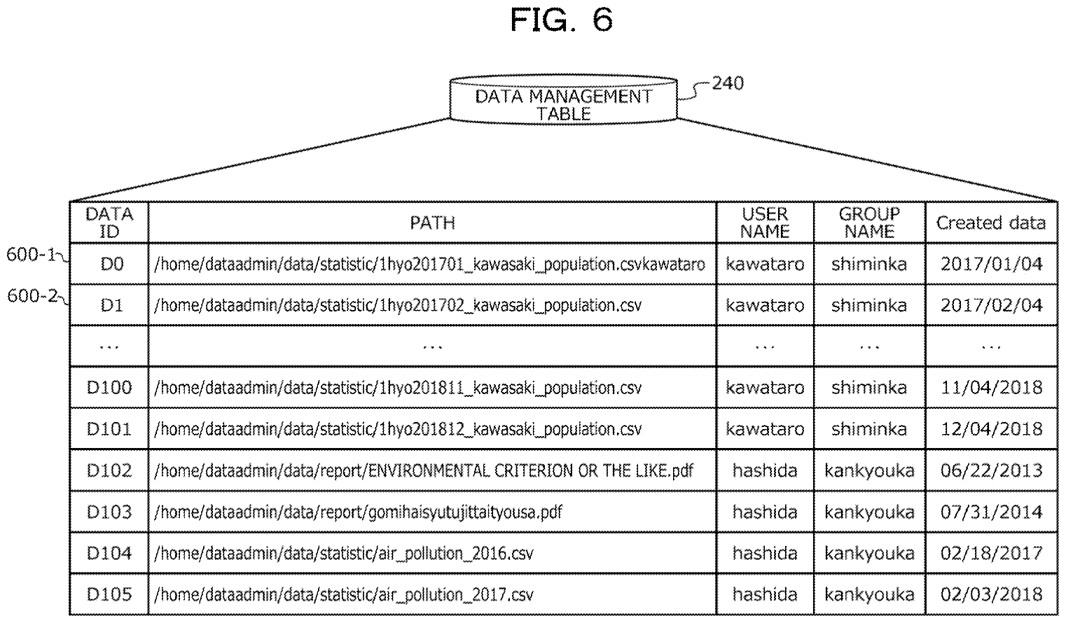

The metadata store 230 stores metadata. The metadata store 230 is, for example, an object DB such as a Mongo DB that stores metadata (JSON object). A specific example of the metadata will be described later with reference to FIG. 5. The data management table 240 is a table to manage the data to be processed. Storage content of the data management table 240 will be described later with reference to FIG. 6.

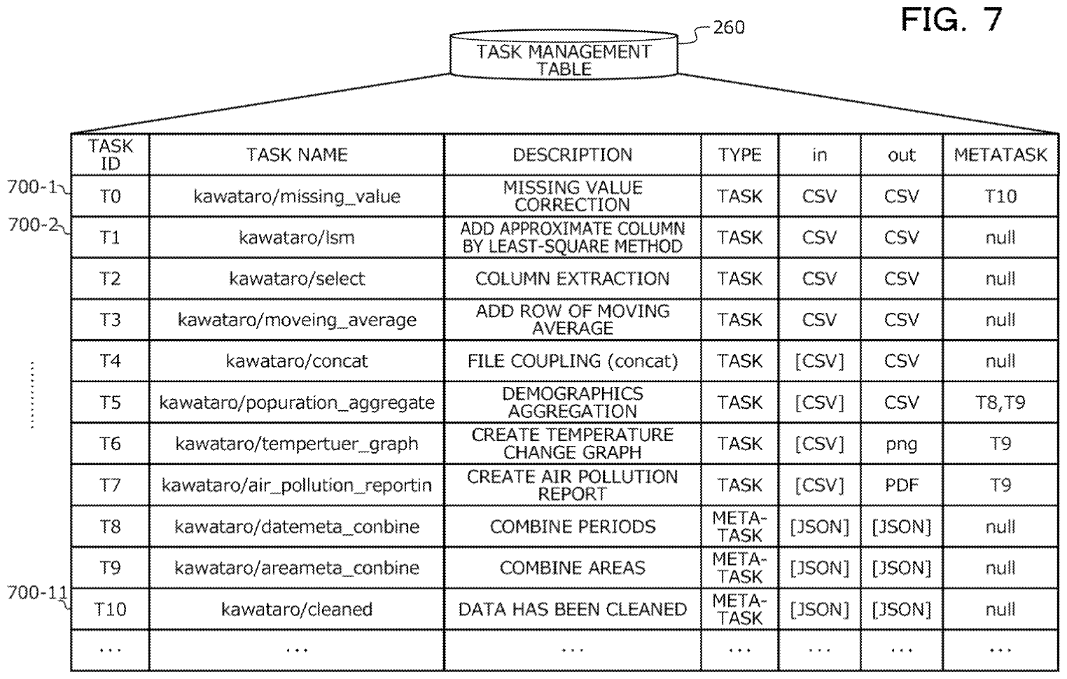

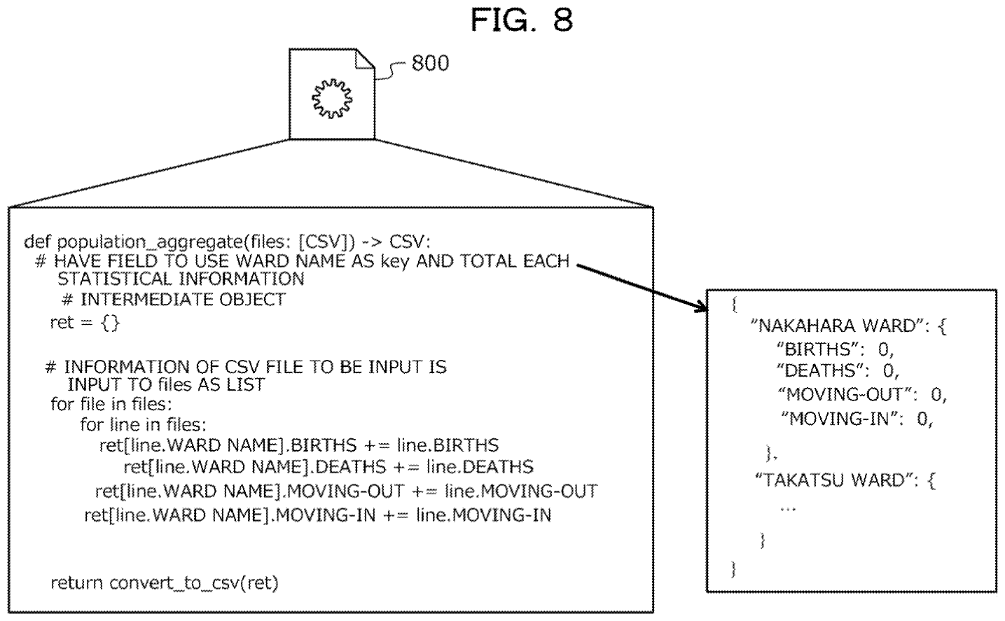

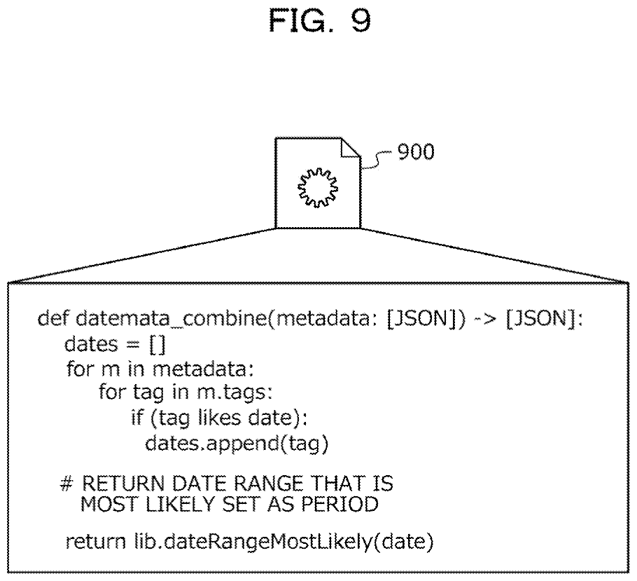

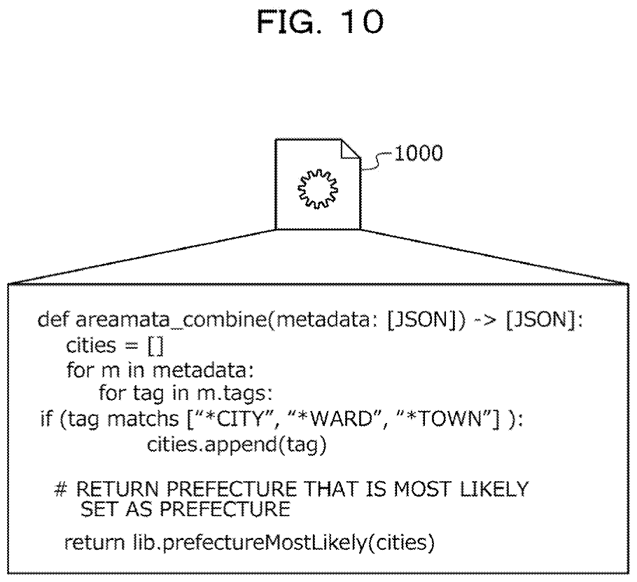

The task repository 250 is a repository that stores entities of tasks and metatasks. A specific example of the task will be described later with reference to FIG. 8. Furthermore, a specific example of the metatask will be described later with reference to FIGS. 9 and 10. The task management table 260 is a table to manage tasks and metatasks. Storage content of the task management table 260 will be described later with reference to FIG. 7.

The client device 201 is a computer used by a user of the information processing system 200. The user is, for example, a data scientist who analyzes data or the like, a designer of tasks and metatasks, or the like. The client device 201 is, for example, a personal computer (PC), a tablet PC, a smartphone, or the like.

Note that, here, the information processing device 101 and the client device 201 are separately provided. However, the present embodiment is not limited to this. For example, the information processing device 101 may be implemented by the client device 201.

Furthermore, the information processing system 200 may include a relational database (RDB), a file system, a cloud storage, a distributed processing platform, or the like. In this case, for example, the information processing device 101 can acquire various types of data from the RDB, the file system, the cloud storage, or the like and execute various tasks using the distributed processing platform.

(Exemplary Hardware Configuration of Information Processing Device 101)

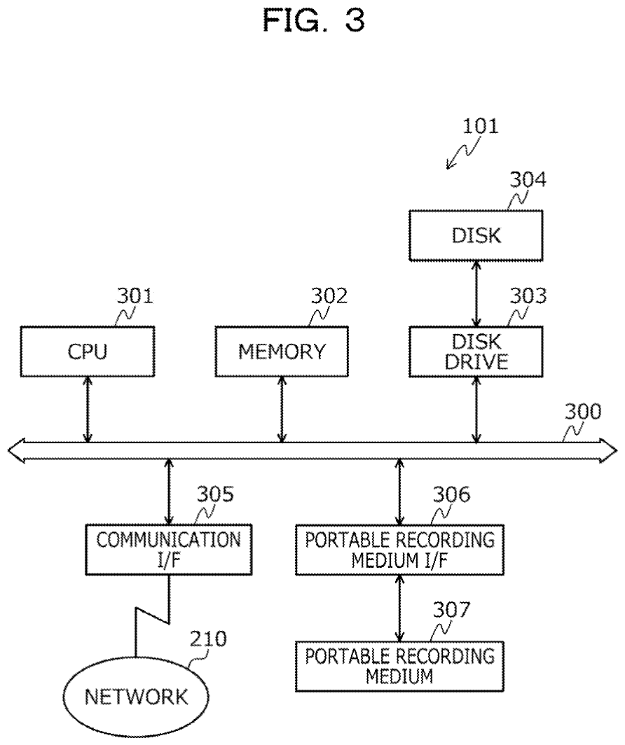

Next, an exemplary hardware configuration of the information processing device 101 will be described with reference to FIG. 3.

FIG. 3 is a block diagram illustrating an exemplary hardware configuration of the information processing device 101. In FIG. 3, the information processing device 101 includes a central processing unit (CPU) 301, a memory 302, a disk drive 303, a disk 304, a communication interface (I/F) 305, a portable recording medium I/F 306, and a portable recording medium 307. Furthermore, the individual components are connected to one another by a bus 300, respectively.

Here, the CPU 301 performs overall control of the information processing device 101. The CPU 301 may include a plurality of cores. The memory 302 includes, for example, a read only memory (ROM), a random access memory (RAM), a flash ROM, or the like. Specifically, for example, the flash ROM stores operating system (OS) programs, the ROM stores application programs, and the RAM is used as a work area for the CPU 301. The programs stored in the memory 302 are loaded into the CPU 301 to cause the CPU 301 to execute coded processing.

The disk drive 303 controls reading and writing of data from and into the disk 304, under the control of the CPU 301. The disk 304 stores data written under the control of the disk drive 303. The disk 304 may be a magnetic disk, an optical disk, or the like, for example.

The communication I/F 305 is connected to the network 210 through a communication line and is connected to an external computer (for example, client device 201 illustrated in FIG. 2) via the network 210. Then, the communication I/F 305 then manages an interface between the network 210 and the inside of the device, and controls input and output of data from an external computer. For example, a modem, a LAN adapter, or the like can be employed as the communication I/F 305.

The portable recording medium I/F 306 controls reading/writing of data from/to the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, or the like.

Note that the information processing device 101 may include, for example, a solid state drive (SSD), an input device, a display, and the like in addition to the components described above. Furthermore, the information processing device 101 does not need to include, for example, the disk drive 303, the disk 304, the portable recording medium I/F 306, and the portable recording medium 307 of the components described above. Furthermore, the client device 201 illustrated in FIG. 2 can be implemented by a hardware configuration similar to that of the information processing device 101. However, the client device 201 includes an input device and a display in addition to the components described above.

(Specific Example of Data to Be Processed)

Next, a specific example of the data to be processed will be described with reference to FIG. 4.

FIG. 4 is an explanatory diagram illustrating a specific example of the data to be processed. In FIG. 4, data 400 is an example of data stored in the data lake 220 (refer to FIG. 2) and illustrates the numbers of births, deaths, persons who move in, and persons who move out in each ward. Note that, in the example in FIG. 4, the data 400 is expressed in a table format. However, the data 400 is, for example, a CSV-format file.

(Specific Example of Metadata)

Next, a specific example of the metadata will be described with reference to FIG. 5.

FIG. 5 is an explanatory diagram illustrating a specific example of the metadata. In FIG. 5, metadata 500 is an example of metadata stored in the metadata store 230 (refer to FIG. 2) and is an information group (for example, tags) to explain meaning of the data 400 illustrated in FIG. 4.

The metadata 500 includes, for example, information indicating an identifier (id) of the metadata 500 and a date and time when the metadata 500 is created (CreatedDate). Furthermore, the metadata 500 includes information indicating an identifier of the data 400 (file_id) to which the metadata 500 is set, an author (author), or the like. According to the metadata 500, for example, it is understood that the data 400 is statistical data obtained by totaling demographics in Kawasaki City in October, 2016 for each ward.

(Storage Content of Data Management Table 240)

Next, the storage content of the data management table 240 included in the information processing device 101 will be described with reference to FIG. 6. Note that various tables or the like 220, 230, 240, 250, and 260 illustrated in FIG. 2 are implemented, for example, by storage devices such as the memory 302 or the disk 304 of the information processing device 101 illustrated in FIG. 3.

FIG. 6 is an explanatory diagram illustrating an example of the storage content of the data management table 240. In FIG. 6, the data management table 240 includes fields of a data ID, a path, a user name, a group name, and created data. By setting information to each field, data management information (for example, data management information 600-1 and 600-2) is stored as records.

Here, the data ID is an identifier that uniquely identifies data to be processed. The identifier “file_id” illustrated in FIG. 5 corresponds to the data ID. The path indicates a location where the data to be processed is stored. The user name is a name of a user who registers the data to be processed. The group name is a name of a group to which the user belongs. The created data indicates a date when the data to be processed is generated (registered).

(Storage Content of Task Management Table 260)

Next, the storage content of the task management table 260 will be described with reference to FIG. 7.

FIG. 7 is an explanatory diagram illustrating an example of the storage content of the task management table 260. In FIG. 7, the task management table 260 includes fields of a task ID, a task name, a description, a type, in, out, and a metatask. By setting information to each field, task management information (for example, task management information 700-1 to 700-11) is stored as records.

Here, the task ID is an identifier that uniquely identifies processing of a task or a metatask. The task name is a name of the processing of the task or the metatask. The task name is expressed, for example, by a combination of the user name and a repository name. The description is explanation of the processing of the task or the metatask. The type indicates whether the processing identified on the basis of the task ID is a task or a metatask. The type “task” indicates a task. The type “metatask” indicates a metatask.

The field in indicates a data format to be input to the processing identified on the basis of the task ID. The field out indicates a data format to be output from the processing identified on the basis of the task ID. The metatask indicates a task ID of a metatask corresponding to the processing identified on the basis of the task ID. Note that, in a case where no metatask corresponding to the task exists or the processing identified on the basis of the task ID is a metatask, “null” is set to the metatask field.

(Specific Example of Task)

Next, a specific example of the task will be described with reference to FIG. 8.

FIG. 8 is an explanatory diagram illustrating a specific example of the task. In FIG. 8, a task 800 is an example of a task stored in the task repository 250. In the task 800, a function that receives a list of CSV files and returns the CSV files is described. However, it is assumed that processing for using the CSV files be hidden.

Specifically, for example, in the task 800, processing for totaling each piece of statistical information (the numbers of births, deaths, moving-in, and moving-out) using a ward name as a key is described. The task 800 corresponds to, for example, a task with a task ID “T5”.

(Specific Example of Metatask)

Next, a specific example of the metatask will be described with reference to FIGS. 9 and 10.

FIG. 9 is an explanatory diagram (part 1) illustrating a specific example of the metatask. In FIG. 9, a metatask 900 is an example of a metatask stored in the task repository 250. In the metatask 900, processing for returning a date range that is most likely set as a period is described. The metatask 900 corresponds to, for example, a metatask with a task ID “T8” corresponding to the task 800 (task ID: T5) illustrated in FIG. 8

FIG. 10 is an explanatory diagram (part 2) illustrating a specific example of the metatask. In FIG. 10, a metatask 1000 is an example of a metatask stored in the task repository 250. In the metatask 1000, processing for returning a prefecture that is most likely set as a prefecture is described. The metatask 1000 corresponds to, for example, a metatask with a task ID “T9” corresponding to the task 800 (task ID: T5) illustrated in FIG. 8.

(Exemplary Functional Configuration of Information Processing Device 101)

Next, an exemplary functional configuration of the information processing device 101 according to the first embodiment will be described.

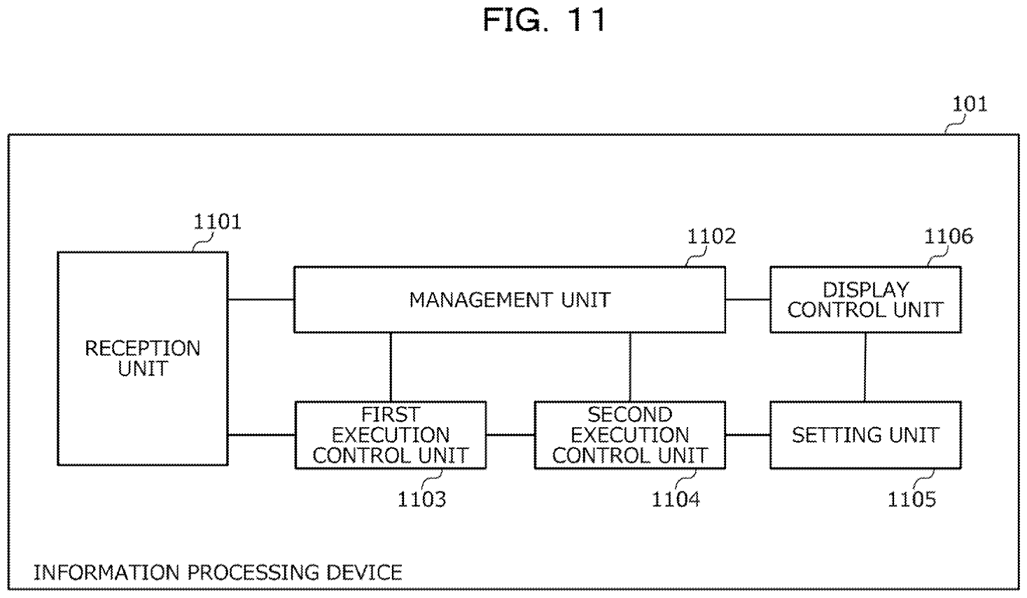

FIG. 11 is a block diagram illustrating an exemplary functional configuration of the information processing device 101. In FIG. 11, the information processing device 101 includes a reception unit 1101, a management unit 1102, a first execution control unit 1103, a second execution control unit 1104, a setting unit 1105, and a display control unit 1106. Specifically, for example, the reception unit 1101 to the display control unit 1106 implement functions by executing programs stored in a storage device such as the memory 302, the disk 304, or the portable recording medium 307 illustrated in FIG. 3 by the CPU 301 or by the communication I/F 305. The processing result of each functional unit is stored in, for example, a storage device such as the memory 302 or the disk 304.

The reception unit 1101 receives a task registration request. Here, the task registration request is to request the information processing system 200 to register a task. The task registration request includes, for example, a task to be registered (for example, task 800 illustrated in FIG. 8) and the information indicating the task name, the description, the type, input/output data, or the like.

The task registration request is issued by, for example, the client device 201 (refer to FIG. 2) used by the designer of the task. In this case, for example, the reception unit 1101 receives the task registration request from the client device 201 so as to receive the task registration request. The task requested to be registered is, for example, stored in the task repository 250.

Furthermore, the reception unit 1101 receives a metatask registration request. Here, the metatask registration request is to request the information processing system 200 to register a metatask. The metatask registration request includes, for example, a metatask to be registered (for example, metatasks 900 and 1000 illustrated in FIGS. 9 and 10) and the information indicating the task name, the description, the type, the input/output data, or the like. Furthermore, the metatask registration request includes information for specifying a task corresponding to the metatask, for example, a task ID, a task name, a description, or the like.

The metatask registration request is issued by, for example, the client device 201 used by the designer of the metatask. In this case, for example, the reception unit 1101 receives the metatask registration request from the client device 201 so as to receive the metatask registration request. The metatask requested to be registered is, for example, stored in the task repository 250.

The management unit 1102 manages the metatask in association with a task. Here, the task is processing for outputting new data by processing or calculating data. The metatask is processing for creating new metadata on the basis of metadata set to data to be processed for new data obtained by executing the task on the data to be processed.

Specifically, for example, the management unit 1102 stores task management information of the task in the task management table 260 illustrated in FIG. 7 in response to the task registration request. At this time, a task ID that uniquely identifies the task is added to the task. Furthermore, the information set to each field of the task management information is specified, for example, from the information included in the task registration request. However, at this point of time, “null” is set to a metatask field.

Furthermore, for example, the management unit 1102 stores task management information of the metatask in the task management table 260 in response to the metatask registration request. At this time, a task ID that uniquely identifies the metatask is added to the metatask. Furthermore, the information set to each field of the task management information is specified, for example, from the information included in the metatask registration request. However, “null” is set to the metatask field.

Furthermore, the management unit 1102 refers to the information for specifying the task included in the metatask registration request and specifies a task corresponding to the metatask. Then, the management unit 1102 sets a task ID of the metatask to the metatask field in task management information of the specified task. As a result, it is possible to manage the metatask so that the metatask corresponding to the task can be specified from the task ID of the task.

Furthermore, the reception unit 1101 receives a task execution request. Here, the task execution request is to request to execute a task. The task execution request includes, for example, information for specifying a task to be executed (for example, task ID, task name, or the like) and information for specifying data to be processed (for example, data ID).

In the following description, the task to be executed may be referred to as a “task tk”. Furthermore, a metatask corresponding to the task tk may be referred to as a “metatask mt”.

The first execution control unit 1103 executes the task tk in response to the task execution request. Specifically, for example, the first execution control unit 1103 acquires the task tk to be executed that is specified from the task execution request from the task repository 250. Furthermore, the first execution control unit 1103 refers to the data management table 240 illustrated in FIG. 6 and acquires data to be processed specified from the task execution request from the data lake 220 (refer to FIG. 2). Then, the first execution control unit 1103 executes the acquired task tk on the single or the plurality of pieces of acquired data. Note that new data obtained by executing the task tk on the single or the plurality of pieces of data is stored, for example, in the data lake 220.

When the task tk is executed on the single or the plurality of pieces of data by the first execution control unit 1103, the second execution control unit 1104 executes the metatask mt that is managed in association with the task tk and creates new metadata on the basis of metadata set to each of the single or the plurality of pieces of data.

Specifically, for example, in a case where the new data is obtained by executing the task tk on the single or the plurality of pieces of data, the second execution control unit 1104 specifies the metatask mt corresponding to the task tk. More specifically, for example, the second execution control unit 1104 refers to the task management table 260 and specifies a task ID of the metatask mt corresponding to the task tk from task management information of the task tk.

Next, the second execution control unit 1104 acquires the metatask mt specified from the specified task ID from the task repository 250. Furthermore, the second execution control unit 1104 acquires metadata of each of the single or the plurality of pieces of data to be processed by the task tk from the metadata store 230 (refer to FIG. 2). The metadata corresponding to each piece of data is specified, for example, from a data ID of each piece of data.

In other words, for example, the second execution control unit 1104 acquires metadata including a data ID of each piece of the data to be processed from the metadata store 230 as the metadata of the data. Then, the second execution control unit 1104 sets metadata obtained by executing the acquired metatask mt using the single or the plurality of pieces of acquired metadata as an input, as new metadata. Note that the author (author) included in the new metadata may be specified, for example, by further referring to data management information of the new data (for example, refer to FIG. 6). Furthermore, description included in the new metadata may be specified, for example, by further referring to the task management information of the metatask mt (for example, refer to FIG. 7).

Furthermore, in a case where the plurality of metatasks mt that is managed in association with the task tk is acquired, the second execution control unit 1104 executes, for example, each of the plurality of metatasks mt. In this case, each of the plurality of metatasks mt creates new metadata respectively on the basis of the metadata set to each of the single or the plurality of pieces of data. For example, the task tk with the task ID “T5” is managed in association with the metatask mt with the task ID “T8” and the metatask mt with the task ID “T9”. In this case, the second execution control unit 1104 executes, for example, the metatask mt with the task ID “T8” and the metatask mt with the task ID “T9”.

In the following description, the new data obtained by executing the task tk may be referred to as “new data”. Furthermore, the new metadata created by executing the metatask mt may be referred to as “new metadata”.

The setting unit 1105 sets the new metadata created by the second execution control unit 1104 to the new data obtained by executing the task tk on the single or the plurality of pieces of data by the first execution control unit 1103. Specifically, for example, in a case where a single piece of new metadata is created, the setting unit 1105 sets a data ID of the new data to the new metadata. More specifically, for example, the setting unit 1105 sets the data ID of the new data to file_id (refer to FIG. 5) of the new metadata. Then, the setting unit 1105 stores the new metadata in the metadata store 230.

On the other hand, in a case where the second execution control unit 1104 creates a plurality of pieces of new metadata, it is not possible to uniquely determine metadata corresponding to the new data. In this case, for example, the setting unit 1105 may set each of the plurality of pieces of created new metadata to the new data as metadata candidates.

Specifically, for example, the setting unit 1105 sets a data ID of the new data and sets a candidate flag to each of the plurality of pieces of created new metadata. The candidate flag is information indicating that the data is a metadata candidate. Then, the setting unit 1105 stores the new metadata in the metadata store 230.

As a result, the new metadata can be stored in the metadata store 230 in a state where it is possible to specify the metadata candidate as a metadata candidate for the new data.

The display control unit 1106 selectably displays the plurality of metadata candidates set to the new data by the setting unit 1105. Specifically, for example, the display control unit 1106 may display an operation screen used to select metadata of the new data from among the plurality of metadata candidates set to the new data on the client device 201.

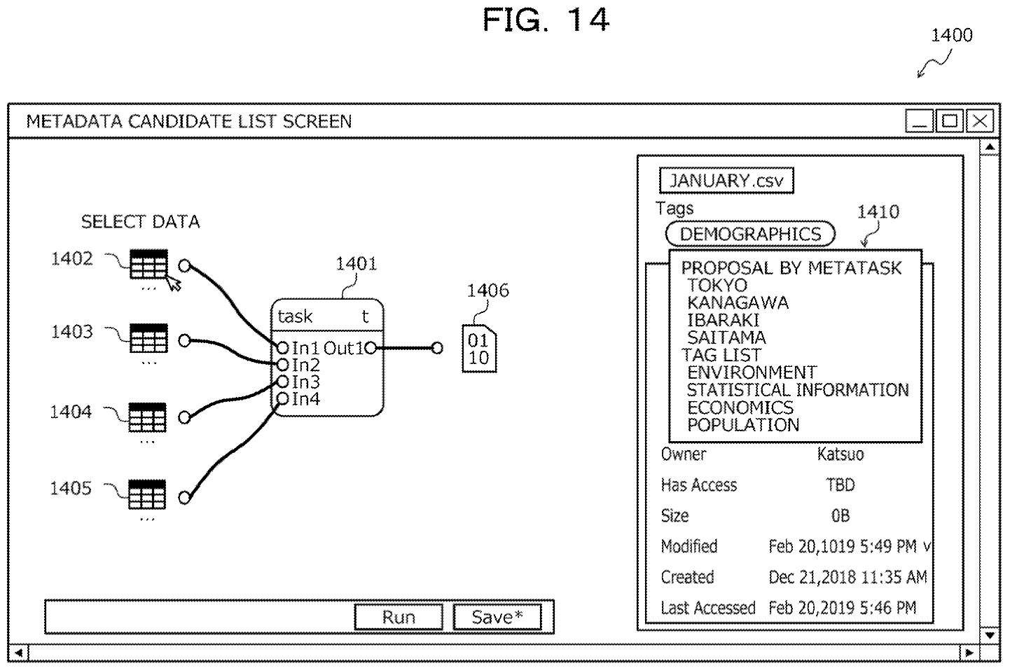

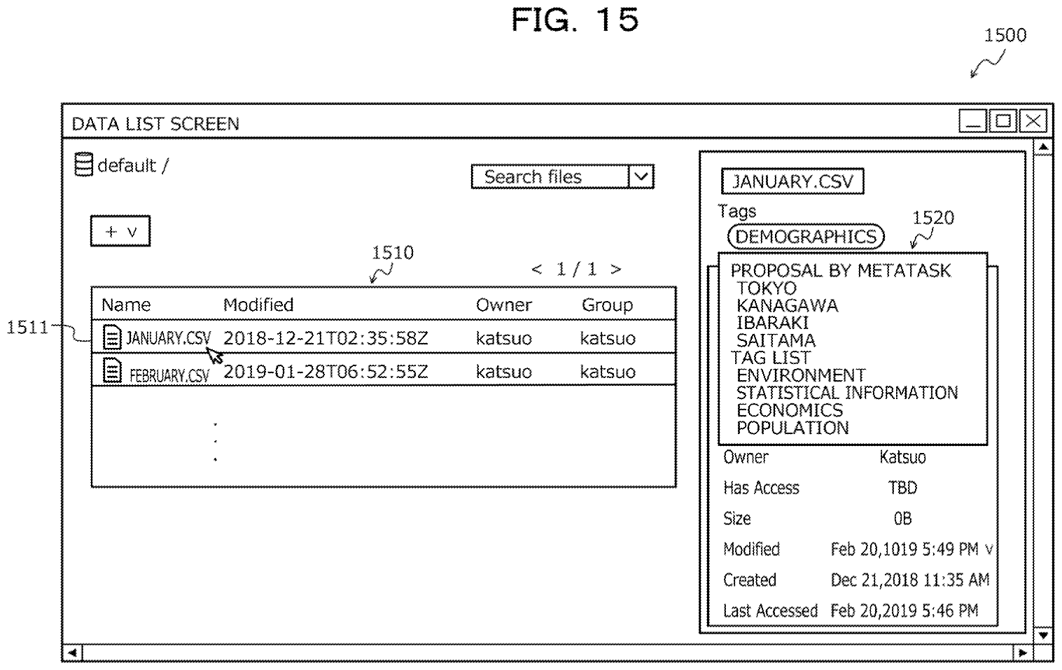

Note that a screen example of the operation screen used to select the metadata of the new data from among the plurality of metadata candidates will be described later with reference to FIGS. 14 and 15.

The setting unit 1105 sets the selected metadata candidate to the new data as the metadata in response to that any one of metadata candidates is selected from among the plurality of metadata candidates. Specifically, for example, the setting unit 1105 deletes the metadata candidates other than the metadata candidate selected from among the plurality of metadata candidates from the metadata store 230. Furthermore, the setting unit 1105 deletes a candidate flag set to the selected metadata candidate in the metadata store 230.

As a result, the metadata candidate selected from among the plurality of metadata candidates by the user can be associated with new data as new metadata.

Note that each functional unit of the information processing device 101 may be implemented by a plurality of computers in the information processing system 200 (for example, information processing device 101 and client device 201). For example, the management unit 1102 may be implemented by the information processing device 101, and functional units other than the management unit 1102 may be implemented by the client device 201. In this case, for example, the client device 201 accesses the information processing device 101 and registers or acquires tasks tk or metatasks mt.

(Behavior Example of Information Processing Device 101)

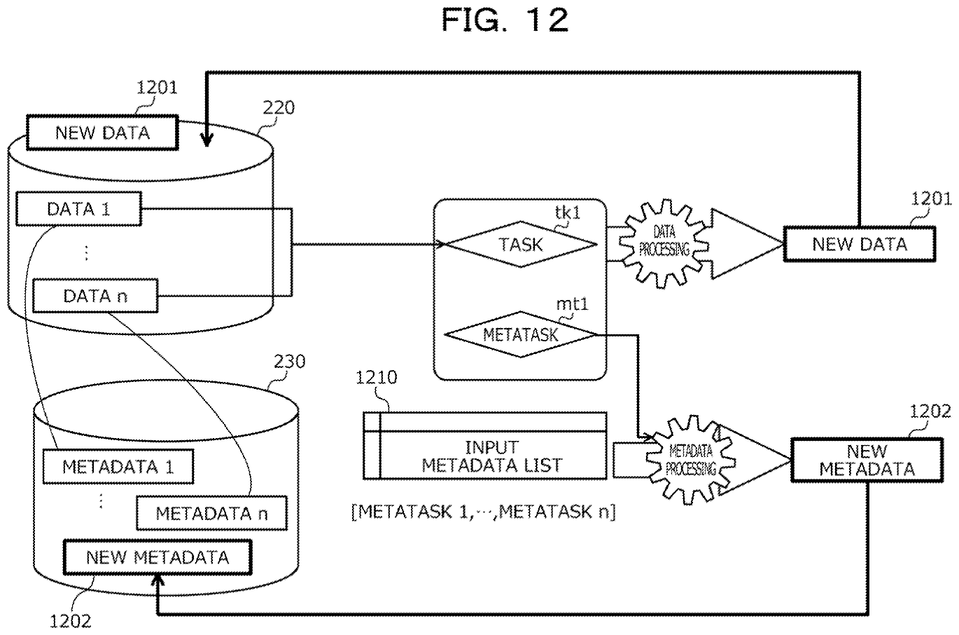

Next, a behavior example of the information processing device 101 according to the first embodiment will be described with reference to FIG. 12.

FIG. 12 is an explanatory diagram illustrating a behavior example of the information processing device 101 according to the first embodiment. Here, a case is assumed where the reception unit 1101 receives a task execution request to request execution of a task tk1. Furthermore, the data to be processed is set as “data 1 to n (n: natural number equal to or more than two).

In this case, the first execution control unit 1103 executes the task tk1 on the data to be processed 1 to n. Here, a case is assumed where new data 1201 is generated as a result of executing the task tk1 on the data 1 to n. The new data 1201 is stored, for example, in the data lake 220.

In a case where the new data 1201 is obtained by executing the task tk1 on the data 1 to n, the second execution control unit 1104 acquires a metatask mt1 corresponding to the task tk1 from the task repository 250. Furthermore, the second execution control unit 1104 acquires metadata 1 to n respectively set to the data to be processed 1 to n from the metadata store 230 and records the acquired data to an input metadata list 1210.

Then, the second execution control unit 1104 executes the acquired metatask mt1 using the input metadata list 1210 as an input. Here, a case is assumed where new metadata 1202 is created on the basis of the metadata 1 to n as a result of executing the metatask mt1 using the input metadata list 1210 as an input.

In this case, the setting unit 1105 sets the created new metadata 1202 to the new data 1201 obtained by executing the task tk1. For example, the setting unit 1105 sets a data ID of the new data 1201 to the new metadata 1202 and stores the new metadata 1202 in the metadata store 230.

As a result, it is possible to set the new metadata 1202 obtained by executing the metatask mt1 using the metadata 1 to n respectively set to the data 1 to n as inputs, to the new data 1201 obtained by executing the task tk1 on the data 1 to n.

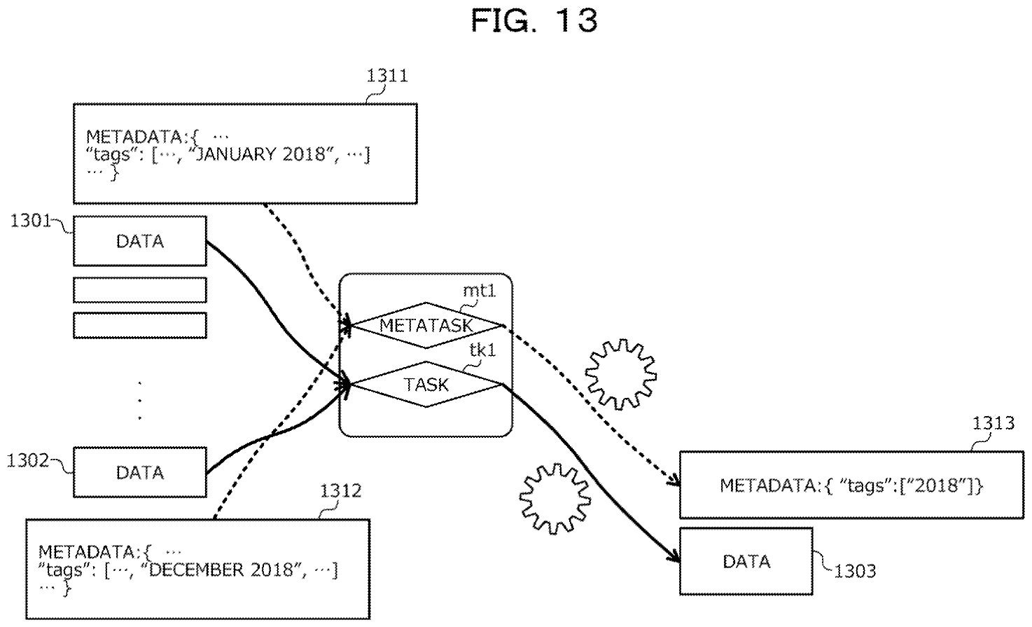

Here, a usage example of the metatask mt1 will be described with reference to FIG. 13.

FIG. 13 is an explanatory diagram illustrating a usage example of the metatask mt1. Here, the task tk1 is assumed as processing for aggregating birth rate data of each month in 2018 (for example, data 1301 and 1302) and acquiring the total in 2018. Furthermore, metadata indicating the year and month (for example, metadata 1311 and 1312) is set to each piece of the birth rate data. Furthermore, the metatask mt1 is assumed as processing for outputting a data range that is most likely set as a period.

In this case, the first execution control unit 1103 (data processing mechanism) executes the task tk1 on the birth rate data of each month in 2018. Here, data 1303 is generated as a result of executing the task tk1. The data 1303 is information indicating the total of the birth rate of each month in 2018.

Furthermore, in a case where the data 1303 is obtained, the second execution control unit 1104 (meta processing mechanism) executes the metatask mt1 corresponding to the task tk1 using metadata respectively set to each birth data (for example, metadata 1311 and 1312) as inputs. Here, metadata 1313 is generated as a result of executing the metatask mt1.

The metadata 1313 is information that indicates “2018” that is most likely set as a period determined from the metadata (for example, metadata 1311 and 1312) set to each piece of the birth rate data of each month in 2018.

Note that another specific example of the task tk is processing for combining demographic data of each municipality in a prefecture. In this case, the metatask mt corresponding to the task tk is processing for outputting an upper concept of each municipality as a tag. For example, in a case where demographic data of each city (Kawasaki city, Yokohama city, or the like) in Kanagawa is given to the task tk, metadata indicating “Kanagawa” is created. Furthermore, in a case where demographic data of each city (Kobe city, Amagasaki city, or the like) in Hyogo is given to the task tk, metadata indicating “Hyogo” is created. In other words, for example, even if the metatask is the same, when a dataset to be given as an input differs, an output differs according to the dataset.

(Screen Example of Operation Screen Used to Select Metadata of New Data)

A screen example of an operation screen used to select metadata of new data from among a plurality of metadata candidates will be described with reference to FIGS. 14 and 15. The operation screen used to select the metadata of the new data is displayed, for example, on the client device 201.

FIG. 14 is an explanatory diagram (part 1) illustrating a screen example of the operation screen used to select the metadata of the new data. In FIG. 14, a metadata candidate list screen 1400 is an example of an operation screen used to select metadata to be set to data from among a plurality of metadata candidates.

In the metadata candidate list screen 1400, icons 1401 to 1406 are displayed. The icon 1401 indicates a task tk. The icons 1402 to 1405 indicate data to be processed input to the task tk. The icon 1406 indicates data obtained by executing the task tk.

In the metadata candidate list screen 1400, when any one of the icons indicating the data is selected through a user's operation input using an input device (not illustrated) of the client device 201, a metadata candidate list is displayed. The metadata candidate list is a list of a plurality of metadata candidates set to the data indicated by the selected icon. The plurality of metadata candidates is displayed as a group.

For example, when the icon 1402 is selected, a metadata candidate list 1410 is displayed. The metadata candidate list 1410 is a list of the plurality of metadata candidates (for example, Tokyo, Kanagawa, Ibaraki, Saitama) set to the data indicated by the icon 1402. Note that the metadata candidate set to the data indicated by the icon 1402 is metadata, to which a data ID of the data indicated by the icon 1402 is set and a candidate flag is set, stored in the metadata store 230.

When any one of the metadata candidates is selected through a user's operation input in the metadata candidate list 1410, the selected metadata candidate is set to the data indicated by the icon 1402 as metadata. For example, when a metadata candidate “Tokyo” is selected, the metadata candidate “Tokyo” is set to the data indicated by the icon 1402 as metadata.

As a result, a user can select a metadata candidate, set to the data (January.csv) indicated by the icon 1402 as metadata, from among the plurality of metadata candidates obtained by executing the metatask mt.

Note that, in the metadata candidate list screen 1400, for example, the data (January.csv) indicated by the icon 1402 may be pop-up displayed, for example, by double-clicking the icon 1402. As a result, the user can select a metadata candidate set as metadata while confirming content of the data (January.csv).

Furthermore, in the example in FIG. 14, a tag “demographic” that has been already set to the data indicated by the icon 1402 by another method (for example, manually) is displayed. The tag corresponds to metadata. As a result, the user can select a metadata candidate set as metadata after recognizing the tag that has been already set.

FIG. 15 is an explanatory diagram (part 2) illustrating a screen example of the operation screen used to select the metadata of the new data. In FIG. 15, a data list screen 1500 is an example of an operation screen used to select metadata set to data from among a plurality of metadata candidates.

In the data list screen 1500, a data list 1510 is displayed. The data list 1510 is a list of data stored in the data lake 220. In the data list screen 1500, when any one piece of data is selected through a user's operation input, a metadata candidate list is displayed. The metadata candidate list is a list of a plurality of metadata candidates set to the selected piece of data.

For example, when data 1511 is selected, a metadata candidate list 1520 is displayed. The metadata candidate list 1520 is a list of a plurality of metadata candidates set to the data 1511.

When any one of the metadata candidates is selected through a user's operation input in the metadata candidate list 1520, the selected metadata candidate is set to the data 1511 as metadata. For example, when a metadata candidate “Kanagawa” is selected, the metadata candidate “Kanagawa” is set to the data 1511 as metadata.

As a result, a user can select a metadata candidate, set to the data 1511 (January.csv) as metadata, from among the plurality of metadata candidates obtained by executing the metatask mt.

(Information Processing Procedure of Information Processing Device 101)

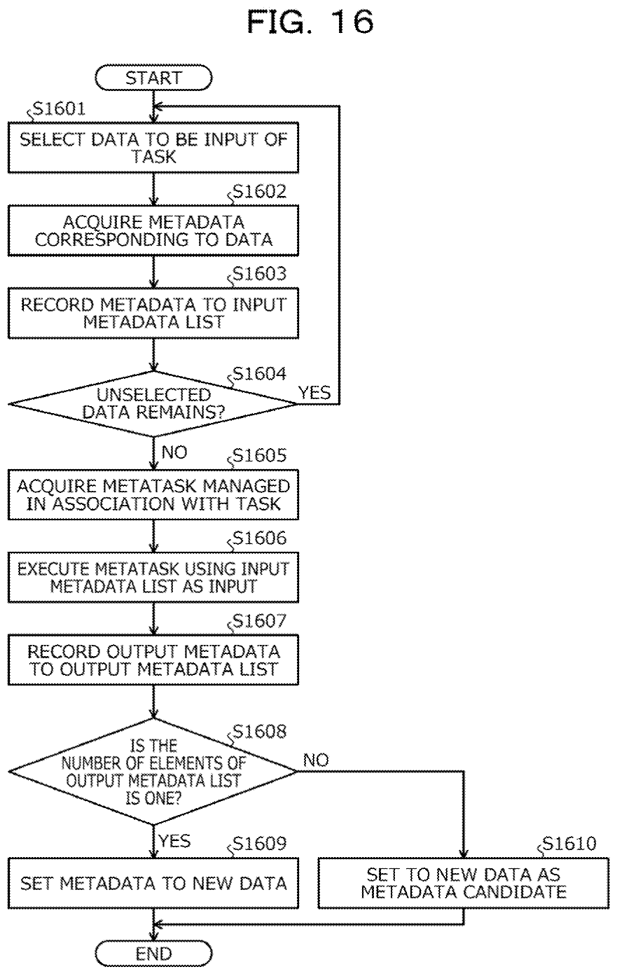

Next, an information processing procedure of the information processing device 101 according to the first embodiment will be described with reference to FIG. 16. Here, a case is assumed where the task tk is executed on a single or a plurality of pieces of data to be processed and new data is obtained.

FIG. 16 is a flowchart illustrating an example of the information processing procedure of the information processing device 101 according to the first embodiment. In the flowchart in FIG. 16, first, the information processing device 101 selects an unselected piece of data from among data to be processed that is input to a task tk (step S1601).

Next, the information processing device 101 acquires metadata corresponding to the selected piece of data from the metadata store 230 (step S1602). Then, the information processing device 101 records the acquired metadata to the input metadata list (step S1603). Next, the information processing device 101 determines whether or not an unselected pieces of data that is not selected remains in the data to be processed (step S1604).

Here, in a case where an unselected piece of data remains (step S1604: Yes), the information processing device 101 returns to step S1601. On the other hand, in a case where no unselected piece of data remains (step S1604: No), the information processing device 101 refers to the task management table 260 and acquires a metatask mt that is managed in association with the task tk from the task repository 250 (step S1605).

Next, the information processing device 101 executes the acquired metatask mt using the input metadata list as an input (step S1606). Then, the information processing device 101 records metadata output by executing the metatask mt using the input metadata list as an input to an output metadata list (step S1607).

Next, the information processing device 101 determines whether or not the number of elements of the output metadata list is one (step S1608). Here, in a case where the number of elements is one (step S1608: Yes), the information processing device 101 sets the metadata recorded to the output metadata list to the new data obtained by executing the task tk (step S1609) and ends the series of processing according to this flowchart.

On the other hand, in a case where the number of elements is plural (step S1608: No), the information processing device 101 sets the plurality of pieces of metadata recorded to the output metadata list to the new data obtained by executing the task tk as metadata candidates (step S1610). Then, the information processing device 101 ends the series of processing according to this flowchart.

As a result, the new metadata obtained by executing the metatask mt on the basis of the metadata set to the data to be an input of the task tk can be set to the new data obtained by executing the task tk. Furthermore, in a case where the plurality of pieces of metadata is obtained by executing the metatask mt, the plurality of pieces of metadata is set to the new data as metadata candidates so that the user can select the metadata later.

As described above, according to the information processing device 101 according to the first embodiment, for the new data obtained by executing the task tk on the data to be processed, the metatask mt for creating the new metadata on the basis of the metadata set to the data to be processed can be managed in association with the task tk.

As a result, it is possible to provide a function for automatically creating metadata of new data obtained by executing the task tk on data when the task tk is executed on the data to which metadata is set.

Furthermore, according to the information processing device 101, when the task tk is executed on the single or the plurality of pieces of data, the metatask mt managed in association with the task tk is executed, and new metadata can be created on the basis of the metadata set to each of the single or the plurality of pieces of data. Then, according to the information processing device 101, the created new metadata can be set to the new data obtained by executing the task tk on the single or the plurality of pieces of data.

As a result, it is possible to automatically set appropriate metadata to the new data obtained by executing the task tk. For example, the metatask mt is designed by the designer of the task tk. The designer of the task tk recognizes what type of processing the task tk executes and can determine what type of information should be created as metadata so as to facilitate data utilization. By designing the metatask mt by a person who recognizes processing content of the task tk, for example, the designer of the task tk, it is possible to automatically create appropriate metadata that facilitates the data utilization.

Furthermore, according to the information processing device 101, in a case where the plurality of pieces of new metadata is created, each of the plurality of pieces of created new metadata can be set to the new data as a metadata candidate.

As a result, in a case where the plurality of pieces of new metadata obtained by executing the metatask mt exists, it is possible to set the plurality of pieces of new metadata to the new data as metadata candidates, and it is possible for the user to select appropriate metadata from among the metadata candidates later.

Furthermore, according to the information processing device 101, it is possible to selectably display the plurality of metadata candidates set to the new data and set the selected metadata candidate to the new data as metadata in response to that any one of the metadata candidates is selected from among the plurality of metadata candidates.

As a result, the metadata candidate selected from among the plurality of metadata candidates by the user can be associated with new data as new metadata.

From these, according to the information processing device 101 and the information processing system 200 according to the first embodiment, it is possible to set metadata as intended by a user to new data in synchronization with data processing and to easily manage data related to task execution, and it is possible to facilitate data utilization.

### Second Embodiment

Next, an information processing device 101 according to a second embodiment will be described. In the second embodiment, the information processing device 101 will be described that sets metadata to data on an input side of a task tk from metadata set to data on an output side of the task tk.

Note that a part similar to the part described in the first embodiment is denoted with the same reference numeral, and illustration and description thereof are omitted. Furthermore, the information processing device 101 according to the second embodiment may have all the functions of the information processing device 101 according to the first embodiment or does not need to have some functions.

(Exemplary Functional Configuration of Information Processing Device 101)

First, an exemplary functional configuration of the information processing device 101 according to the second embodiment will be described. However, because the exemplary functional configuration of the information processing device 101 according to the second embodiment is similar to the exemplary functional configuration of the information processing device 101 according to the first embodiment illustrated in FIG. 11, illustration is omitted. Hereinafter, functional units having functions different from those of the information processing device 101 according to the first embodiment will be described.

A management unit 1102 manages a second metatask in association with a task. Here, the second metatask is processing for creating new metadata for data to be processed on the basis of metadata set to new data obtained by executing a task on the data to be processed.

Specifically, for example, the management unit 1102 stores task management information of the metatask in a task management table 260 in response to a metatask registration request. Furthermore, the management unit 1102 refers to the information for specifying the task included in the metatask registration request and specifies a task corresponding to the metatask. Then, the management unit 1102 sets a task ID of the metatask to the metatask field in task management information of the specified task. As a result, it is possible to manage the metatask so that the metatask corresponding to the task can be specified from the task ID of the task.

In a case where the new data is obtained by executing the task tk on a single or a plurality of pieces of data by a first execution control unit 1103, a second execution control unit 1104 executes the second metatask managed in association with the task tk and creates new metadata on the basis of the metadata set to the new data.

Specifically, for example, the second execution control unit 1104 refers to the task management table 260 and specifies a task ID of the second metatask corresponding to the task tk from the task management information of the task tk. Next, the second execution control unit 1104 acquires the second metatask specified from the specified task ID from a task repository 250.

Furthermore, the second execution control unit 1104 acquires the metadata set to the new data obtained by executing the task tk, from a metadata store 230. For example, the metadata is manually set to the new data obtained by executing the task tk. Then, the second execution control unit 1104 sets the metadata, obtained by executing the acquired second metatask using the acquired metadata as an input, as new metadata.

The setting unit 1105 sets the new metadata created by the second execution control unit 1104 to the single or the plurality of pieces of data to be processed by the task tk. Specifically, for example, in a case where the data to be processed includes a single piece of data, the setting unit 1105 sets a data ID of the data to the new metadata. Then, the setting unit 1105 stores the new metadata in the metadata store 230.

On the other hand, there is a case where the data to be processed includes a plurality of pieces of data. In this case, for example, if the created new metadata includes a single piece of data, the setting unit 1105 may respectively set the created new metadata to each of the plurality of pieces of data. In other words, for example, metadata having the same content (same tag) is set to each of the plurality of pieces of data to be processed.

Furthermore, in a case where the data to be processed includes a plurality of pieces of data, there is a case where a plurality of different pieces of new metadata is created. In this case, it is not possible to uniquely determine which new metadata among the plurality of different pieces of metadata is associated with which data among the plurality of pieces of data to be processed.

Therefore, the setting unit 1105 may set, for example, each of the plurality of pieces of created new metadata to the plurality of pieces of data as metadata candidates. In other words, for example, in a case where the new data is obtained by executing the task tk on the plurality of pieces of data and the plurality of pieces of new metadata is created, the setting unit 1105 sets each of the plurality of pieces of created new metadata to the plurality of pieces of data to be processed as metadata candidates.

Specifically, for example, the setting unit 1105 sets a data ID of each of the plurality of pieces of data to be processed and sets a candidate flag, to each of the plurality of pieces of created new metadata The candidate flag is information indicating that the data is a metadata candidate. Then, the setting unit 1105 stores the new metadata in the metadata store 230.

As a result, the new metadata can be stored in the metadata store 230 in a state where is it possible to specify that the metadata candidate is a metadata candidate for the plurality of pieces of data to be processed.

A display control unit 1106 selectably displays the plurality of metadata candidates set to the plurality of pieces of data by the setting unit 1105. Specifically, for example, the display control unit 1106 may display an operation screen used to select metadata of each of the plurality of pieces of data from among the plurality of metadata candidates set to the plurality of pieces of data, on the client device 201.

The setting unit 1105 sets the selected metadata candidate as metadata in response to that any one of metadata candidates is selected from among the plurality of metadata candidates for each of the plurality of pieces of data. Specifically, for example, the setting unit 1105 deletes a data ID and a candidate flag of other data other than each piece of data set to the metadata candidate selected for each data.

As a result, the metadata candidate selected from among the plurality of metadata candidates by the user can be associated with each piece of data as new metadata.

(Behavior Example of Information Processing Device 101)

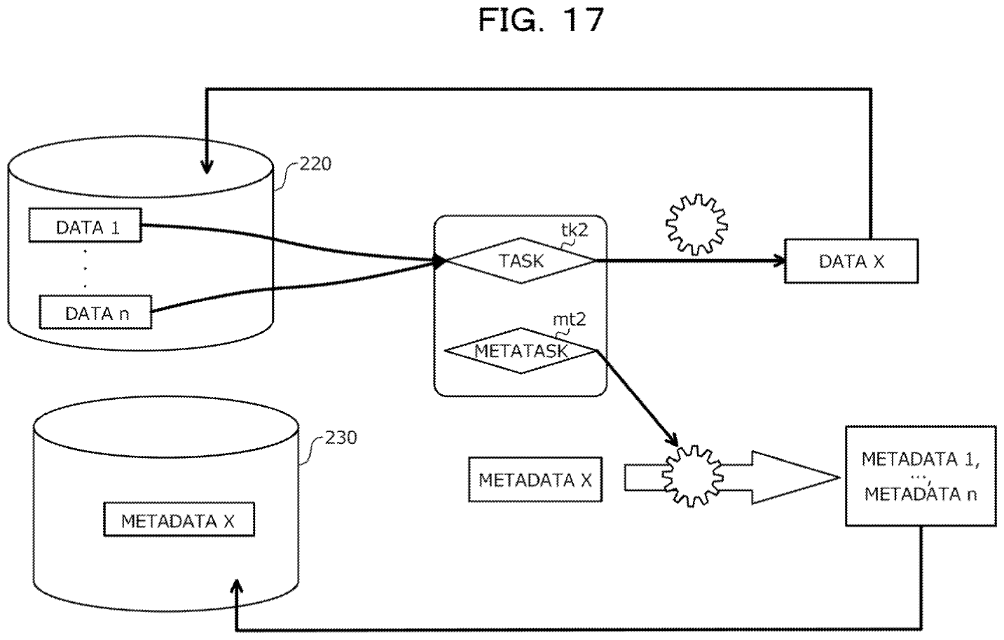

Next, a behavior example of the information processing device 101 according to the second embodiment will be described with reference to FIG. 17.

FIG. 17 is an explanatory diagram illustrating a behavior example of the information processing device 101 according to the second embodiment. Here, a case is assumed where a reception unit 1101 receives a task execution request to request execution of a task tk2. Furthermore, the data to be processed is set as “data 1 to n (n: natural number equal to or more than two).

In this case, the first execution control unit 1103 executes the task tk2 on the data to be processed 1 to n. Here, a case is assumed where data X is generated as a result of executing the task tk2 on the data 1 to n. The data X is stored in the data lake 220. Furthermore, a case is assumed where metadata X is manually set to the data X.

In a case where the data X is obtained by executing the task tk2 on the data 1 to n, the second execution control unit 1104 acquires a metatask mt2 (second metatask) corresponding to the task tk2 from the task repository 250. Furthermore, the second execution control unit 1104 acquires the metadata X set to the data X from the metadata store 230.

Then, the second execution control unit 1104 executes the acquired metatask mt2 using the metadata X as an input. Here, a case is assumed where metadata 1 to n is created on the basis of the metadata X as a result of executing the metatask mt2 using the metadata X as an input.

In this case, the setting unit 1105 sets the created metadata 1 to n to the data to be processed 1 to n by the task tk2. Specifically, for example, the setting unit 1105 sets the metadata 1 to n to the data 1 to n as metadata candidates.

As a result, the metadata 1 to n is stored in the metadata store 230 so that a user can select the metadata later in a state where it is possible to specify that the data 1 to n is a metadata candidate.

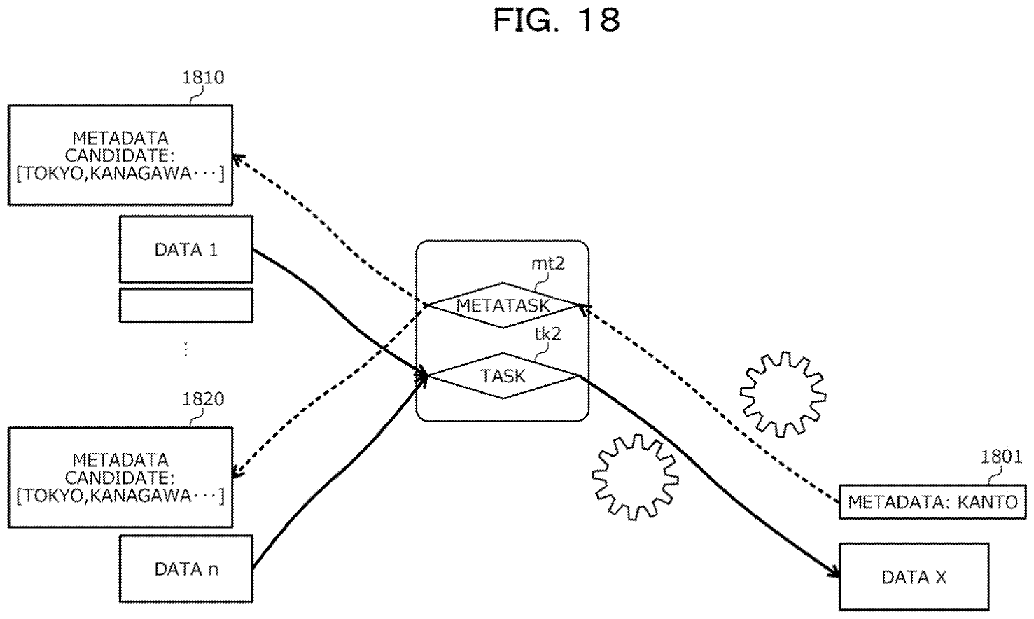

Here, a usage example of the metatask mt2 (second metatask) will be described with reference to FIG. 18.

FIG. 18 is an explanatory diagram illustrating a usage example of the metatask mt2. Here, a case is assumed where the data X is obtained as a result of executing the task tk2 on the data 1 to n. Furthermore, a case is assumed where metadata 1801 is set to the data X. The metadata 1801 indicates Kanto. Furthermore, the metatask mt2 is processing for searching for a lower concept from the metadata on the output side with SPARQL described below.

″select ?o where
{Kanto < rdfs: subPropertyof > ?o}”

In a case where the data X is obtained, the second execution control unit 1104 executes the metatask mt2 using the metadata set to the data X: Kanto as an input. Here, a case is assumed where a plurality of pieces of metadata (for example, Tokyo, Kanagawa, . . . ) is created as a result of executing the metatask mt2. In this case, the setting unit 1105 sets the plurality of pieces of created metadata to the data 1 to n to be processed by the task tk2 as metadata candidates (for example, metadata candidates 1810 and 1820).

As a result, the plurality of pieces of metadata (for example, Tokyo, Kanagawa, . . . ) can be stored in the metadata store 230 so that the user can select the metadata later in a state where it is possible to specify that the metadata candidate is a metadata candidate for the data 1 to n.

(Information Processing Procedure of Information Processing Device 101)

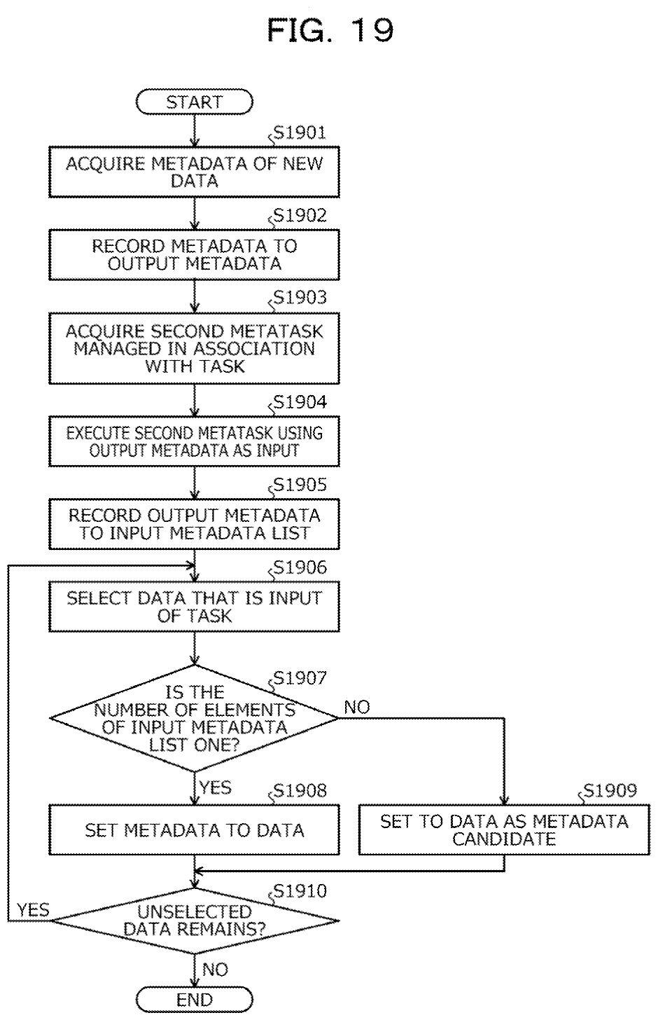

Next, an information processing procedure of the information processing device 101 according to the second embodiment will be described with reference to FIG. 19. Here, a case is assumed where the task tk is executed on a single or a plurality of pieces of data to be processed and new data is obtained.

FIG. 19 is a flowchart illustrating an example of the information processing procedure of the information processing device 101 according to the second embodiment. In the flowchart in FIG. 19, first, the information processing device 101 acquires metadata set to new data obtained by executing the task tk from the metadata store 230 (step S1901).

Next, the information processing device 101 records the acquired metadata to output metadata (step S1902). Then, the information processing device 101 refers to the task management table 260 and acquires a second metatask that is managed in association with the task tk from the task repository 250 (step S1903).

Next, the information processing device 101 executes the acquired second metatask using the output metadata as an input (step S1904). Then, the information processing device 101 records the metadata output by executing the second metatask using the output metadata as an input to an input metadata list (step S1905).

Next, the information processing device 101 selects an unselected piece of data that is not selected from among data to be processed that is an input of the task tk (step S1906). Then, the information processing device 101 determines whether or not the number of elements of the input metadata list is one (step S1907).

Here, in a case where the number of elements is one (step S1907: Yes), the information processing device 101 sets the metadata recorded to the input metadata list to the selected piece of data (step S1908) and proceeds to step S1910. On the other hand, in a case where the number of elements is plural (step S1907: No), the information processing device 101 sets the plurality of pieces of metadata recorded to the input metadata list to the selected piece of data as metadata candidates (step S1909).

Then, the information processing device 101 determines whether or not an unselected piece of data that is not selected remains in the data to be processed (step S1910). Here, in a case where an unselected piece of data remains (step S1910: Yes), the information processing device 101 returns to step S1906. On the other hand, in the case where no unselected piece of data remains (step S1910: No), the information processing device 101 ends the series of processing according to this flowchart.

As a result, the new metadata obtained by executing the second metatask on the basis of the metadata set to the new data obtained by executing the task tk can be set to the data that is an input of the task tk. Furthermore, in a case where the plurality of pieces of metadata is obtained by executing the second metatask, the plurality of pieces of metadata is set to each piece of the data that is the input of the task tk as metadata candidates so that the user can select the metadata later.

As described above, according to the information processing device 101 according to the second embodiment, it is possible to automatically set appropriate metadata to the data to be processed (data on input side) from the metadata set to the new data (data on output side) obtained by executing the task tk. This makes it possible to set metadata as intended by a user to data in synchronization with data processing, and it is possible to facilitate data utilization.

### Third Embodiment

Next, an information processing device 101 according to a third embodiment will be described. In the third embodiment, a case will be described where a task (data processing mechanism) and a metatask (meta processing mechanism) create new metadata in cooperation.

Note that a part similar to the part described in the first and second embodiments is denoted with the same reference numeral, and illustration and description thereof are omitted. Furthermore, the information processing device 101 according to the third embodiment may have all the functions of the information processing device 101 according to the first and second embodiments or does not need to have some functions.

(Exemplary Functional Configuration of Information Processing Device 101)

First, an exemplary functional configuration of the information processing device 101 according to the third embodiment will be described. However, because the exemplary functional configuration of the information processing device 101 according to the third embodiment is similar to the exemplary functional configuration of the information processing device 101 according to the first embodiment illustrated in FIG. 11, illustration is omitted. Hereinafter, functional units having functions different from those of the information processing device 101 according to the first embodiment will be described.

A management unit 1102 manages a third metatask in association with a task tk′. Here, the task tk′ is a task that has a function for outputting information that can be used for metadata of new data obtained by processing data to be processed during execution of the task tk′. The information that can be used for the metadata may be, for example, a metadata candidate or may also be information used to create metadata by processing or calculating the information. Furthermore, the third metatask is processing for creating new metadata on the basis of the information output from the task tk′ for new data obtained by executing the task tk′ on the data to be processed.

A first execution control unit 1103 executes the task tk′ in response to a task execution request. Specifically, for example, the first execution control unit 1103 acquires a task tk′ to be executed that is specified from the task execution request from the task repository 250. Furthermore, the first execution control unit 1103 refers to a data management table 240 and acquires data to be processed specified from the task execution request from a data lake 220. Then, the first execution control unit 1103 executes the acquired task tk′ on the single or the plurality of pieces of acquired data.

A second execution control unit 1104 executes a third metatask that is managed in association with the task tk′ in response to the execution of the task tk′ on the single or the plurality of pieces of data by the first execution control unit 1103 and creates new metadata on the basis of information output from the task tk′ during the execution of the task tk′.

Specifically, for example, the second execution control unit 1104 refers to a task management table 260 and specifies a task ID of the third metatask corresponding to the task tk′ from task management information of the task tk′. Next, the second execution control unit 1104 acquires a third metatask specified from the specified task ID from the task repository 250.

Then, the second execution control unit 1104 executes the acquired third metatask using the information output from the task tk′ as an input and creates new metadata. The setting unit 1105 sets the new metadata created by the second execution control unit 1104 to the new data obtained by executing the task tk on the single or the plurality of pieces of data by the first execution control unit 1103.

(Behavior Example of Information Processing Device 101)

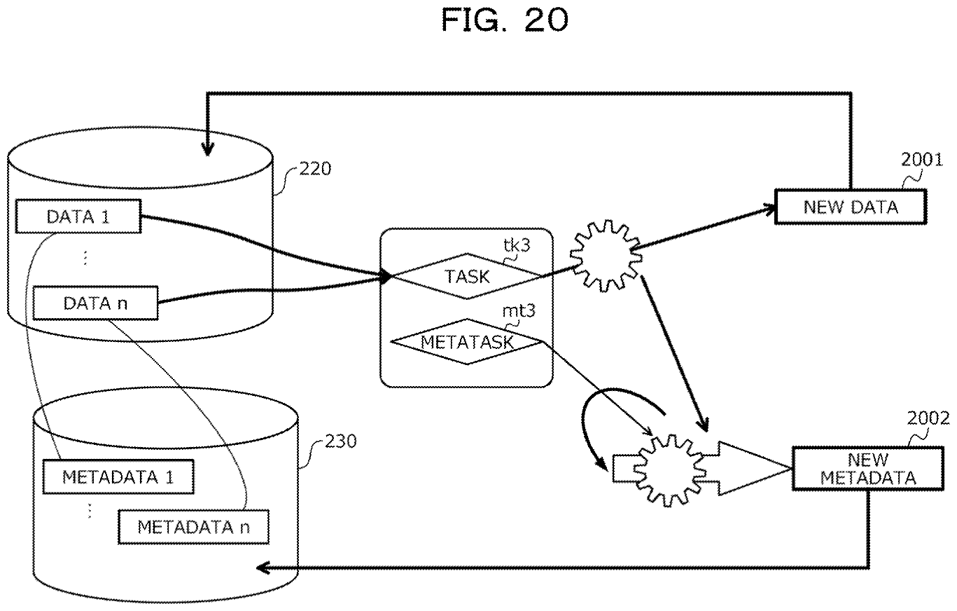

Next, a behavior example of the information processing device 101 according to the third embodiment will be described with reference to FIG. 20.

FIG. 20 is an explanatory diagram illustrating a behavior example of the information processing device 101 according to the third embodiment. Here, a case is assumed where the reception unit 1101 receives a task execution request to request execution of a task tk3. The task tk3 is a task that has a function for outputting information that can be used for metadata of new data obtained by processing data to be processed. Furthermore, the data to be processed is set as “data 1 to n (n: natural number equal to or more than two).

In this case, the first execution control unit 1103 starts to execute the task tk3 on data to be processed 1 to n. Furthermore, the second execution control unit 1104 starts to execute a metatask mt3 that is managed in association with the task tk3 in response to the start of the execution of the task tk3 on the data 1 to n by the first execution control unit 1103. The metatask mt3 is processing for creating new metadata on the basis of the information output from the task tk3 for new data obtained by executing the task tk3 on the data to be processed.

The task tk3 is, for example, processing for converting an address of a nursery school in Takatsu ward, Kawasaki city into coordinates (latitude and longitude). In this case, the information that can be used for the metadata output from the task tk3 is, for example, the converted coordinates. The metatask mt3 is, for example, processing for obtaining the gravity of the coordinates after the conversion, searches for each prefecture/municipality or the like close to the gravity, and creates metadata indicating a ward, a city, or the like that includes the largest number of converted coordinates. Furthermore, another metatask corresponding to the task tk3 includes, for example, processing for creating metadata indicating positional information from the converted coordinates.

Here, a case is assumed where new data 2001 is generated as a result of executing the task tk3 on the data 1 to n. The new data 2001 is stored in the data lake 220. Furthermore, a case is assumed where new metadata 2002 is created on the basis of information output from the task tk3. The new metadata 2002 is information that indicates “Kawasaki” including the largest number of converted coordinates output from the task tk3, for example.

In this case, the setting unit 1105 sets the created new metadata 2002 to the new data 2001 obtained by executing the task tk3. For example, the setting unit 1105 associates a data ID of the new data 2001 with the new metadata 2002 and stores the new metadata 2002 in the metadata store 230.

As a result, it is possible to set the new metadata 2002 obtained by executing the metatask mt3 using the information (converted coordinates) output from the task tk3 as an input to the new data 2001 obtained by executing the task tk3 on the data 1 to n.

(Information Processing Procedure of Information Processing Device 101)

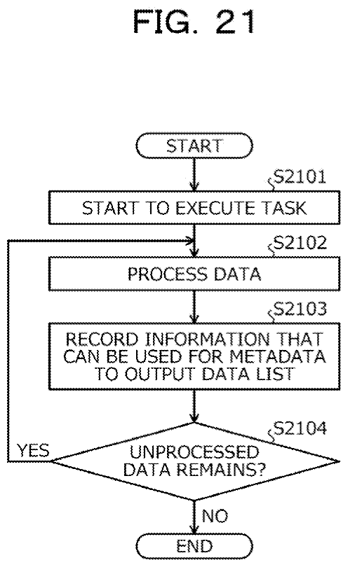

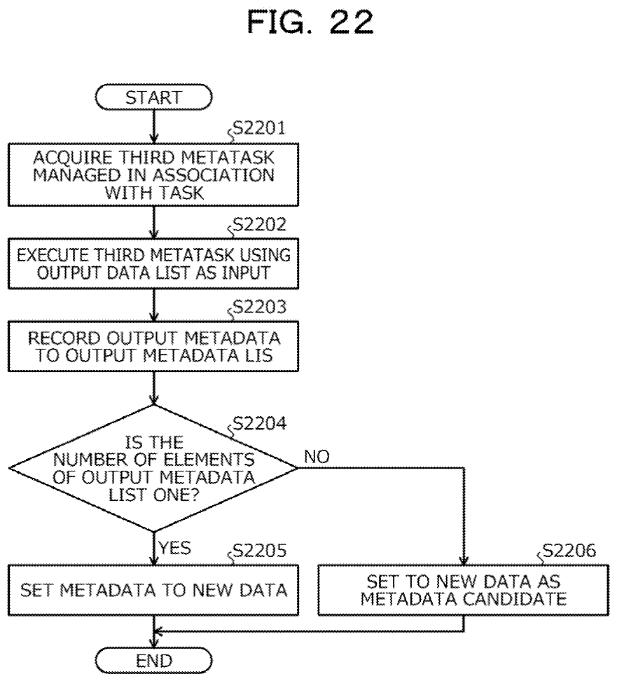

Next, first and second information processing procedures of the information processing device 101 according to the third embodiment will be described with reference to FIGS. 21 and 22.

FIG. 21 is a flowchart illustrating an example of the first information processing procedure of the information processing device 101 according to the third embodiment. In the flowchart in FIG. 21, first, the information processing device 101 starts to execute a task tk′ on a single or a plurality of pieces of data to be processed (step S2101).

Then, the information processing device 101 processes an unprocessed piece of data from among the single or the plurality of pieces of data to be processed (step S2102). Next, the information processing device 101 records information that can be used for metadata of new data obtained by executing the task tk′ to an output data list on the basis of the result of processing the data (step S2103).

Then, the information processing device 101 determines whether or not an unprocessed piece of data from among the single or the plurality of pieces of data to be processed remains (step S2104). Here, in a case where an unprocessed data remains (step S2104: Yes), the information processing device 101 returns to step S2102. On the other hand, in a case where no unprocessed piece of data remains (step S2104: No), the information processing device 101 ends the series of processing according to this flowchart.

As a result, it is possible to output the information used for the metadata of the new data obtained by executing the task tk′ during the execution of the task tk′.

FIG. 22 is a flowchart illustrating an example of the second information processing procedure of the information processing device 101 according to the third embodiment. In the flowchart in FIG. 22, first, the information processing device 101 refers to the task management table 260 in response to the execution of the task tk′ and acquires a third metatask that is managed in association with the task tk′ from the task repository 250 (step S2201).

Next, the information processing device 101 executes the acquired third metatask using an output data list as an input (step S2202). Then, the information processing device 101 records the metadata output by executing the third metatask using the output data list as an input to an output metadata list (step S2203).

Next, the information processing device 101 determines whether or not the number of elements of the output metadata list is one (step S2204). Here, in a case where the number of elements is one (step S2204: Yes), the information processing device 101 sets the metadata recorded to the output metadata list to the new data obtained by executing the task tk′ (step S2205) and ends the series of processing according to this flowchart.

On the other hand, in a case where the number of elements is plural (step S2204: No), the information processing device 101 sets the plurality of pieces of metadata recorded to the output metadata list to the new data obtained by executing the task tk′ as metadata candidates (step S2206). Then, the information processing device 101 ends the series of processing according to this flowchart.

As a result, it is possible to set the new metadata obtained by executing the third metatask using the information output from the task tk′ during the execution of the task tk′ as an input to the new data obtained by executing the task tk′ on the data 1 to n. Furthermore, in a case where the plurality of pieces of metadata is obtained by executing the third metatask, the plurality of pieces of metadata is set to the new data as metadata candidates so that the user can select the metadata later.

As described above, according to the information processing device 101 according to the third embodiment, it is possible for the third metatask (meta processing mechanism) and the task tk′ (data processing mechanism), in cooperation, to automatically set appropriate metadata to the new data on the basis of the information output from the task tk′ (data processing mechanism) during the execution. This makes it possible to set metadata as intended by a user to new data in synchronization with data processing, and it is possible to facilitate data utilization.

Note that each of the embodiments described above may be implemented in combination as long as no contradiction arises. Furthermore, the information processing method described in the present embodiment may be implemented by executing a prepared program on a computer such as a personal computer or a workstation. The present information processing program is recorded on a computer-readable recording medium such as a hard disk, flexible disk, CD-ROM, DVD, or USB memory and is read from the recording medium to be executed by a computer. Additionally, the present information processing program may be distributed via a network such as the Internet.

Furthermore, the information processing device 101 described in the present embodiment can also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
manage a metatask that creates new metadata, in association with a task, on the basis of metadata set to data to be processed for new data obtained by executing the task on the data to be processed;
execute the metatask managed in association with the task when the task is executed on a single or a plurality of pieces of data and create new metadata on the basis of metadata set to each of the single or the plurality of pieces of data; and
set the new metadata to new data obtained by executing the task on the single or the plurality of pieces of data.

2. The information processing device according to claim 1, wherein
the processor,
in a case where the plurality of pieces of new metadata is created, sets each of the plurality of pieces of created new metadata to the new data as a metadata candidate.

3. The information processing device according to claim 2, wherein
the processor selectably displays a plurality of metadata candidates set to the new data, and
sets the selected metadata candidate to the new data as metadata in response to that any one of metadata candidates is selected from among the plurality of metadata candidates.

4. The information processing device according to claim 1, wherein
the processor
manages a second metatask that creates new metadata in association with a task for data to be processed on the basis of metadata set to new data obtained by executing the task on the data to be processed, and
in a case where new data is obtained by executing the task on a single or a plurality of pieces of data, executes the second metatask that is managed in association with the task and creates new metadata on the basis of metadata set to the new data, and
sets the new metadata to the single or the plurality of pieces of data.

5. The information processing device according to claim 4, wherein
the processor,
in a case where the new data is obtained by executing the task on a plurality of pieces of data and the plurality of pieces of new metadata is created, sets each of the plurality of pieces of created new metadata to the plurality of pieces of data as a metadata candidate.

6. The information processing device according to claim 5, wherein
the processor selectably displays a plurality of metadata candidates set to the plurality of pieces of data, and
sets the selected metadata candidate as metadata in response to that any one of metadata candidates is selected from among the plurality of metadata candidates for each of the plurality of pieces of data.

7. The information processing device according to claim 1, wherein
the task has a function that outputs information that is able to be used for metadata of new data obtained by processing data to be processed,
the processor
manages a third metatask that creates new metadata, in association with the task, on the basis of the information output from the task for new data obtained by executing the task on the data to be processed, and
executes the third metatask that is managed in association with the task and creates new metadata on the basis of the information output from the task during execution of the task in response to that the task is executed on a single or a plurality of pieces of data.

8. An information processing system comprising:
a memory; and
a processor coupled to the memory and configured to:
manage a metatask that creates new metadata, in association with a task, on the basis of metadata set to data to be processed for new data obtained by executing the task on the data to be processed;
execute the metatask managed in association with the task when the task is executed on a single or a plurality of pieces of data and create new metadata on the basis of metadata set to each of the single or the plurality of pieces of data; and
set the new metadata to new data obtained by executing the task on the single or the plurality of pieces of data.

9. The information processing system according to claim 8, wherein
the processor,
in a case where the plurality of pieces of new metadata is created, sets each of the plurality of pieces of created new metadata to the new data as a metadata candidate.

10. The information processing system according to claim 9, wherein
the processor selectably displays a plurality of metadata candidates set to the new data, and
sets the selected metadata candidate to the new data as metadata in response to that any one of metadata candidates is selected from among the plurality of metadata candidates.

11. The information processing system according to claim 8, wherein
the processor
manages a second metatask that creates new metadata in association with a task for data to be processed on the basis of metadata set to new data obtained by executing the task on the data to be processed,
in a case where new data is obtained by executing the task on a single or a plurality of pieces of data, executes the second metatask that is managed in association with the task and creates new metadata on the basis of metadata set to the new data, and
sets the new metadata to the single or the plurality of pieces of data.

12. A non-transitory computer-readable recording medium storing an information processing program causing a computer to execute a processing of:
managing a metatask that creates new metadata, in association with a task, on the basis of metadata set to data to be processed for new data obtained by executing the task on the data to be processed;
executing the metatask managed in association with the task when the task is executed on a single or a plurality of pieces of data and create new metadata on the basis of metadata set to each of the single or the plurality of pieces of data; and
setting the new metadata to new data obtained by executing the task on the single or the plurality of pieces of data.

13. The non-transitory computer-readable recording medium according to claim 12, further comprising:
in a case where the plurality of pieces of new metadata is created, setting each of the plurality of pieces of created new metadata to the new data as a metadata candidate.

14. The non-transitory computer-readable recording medium according to claim 13, further comprising:
selectably displaying a plurality of metadata candidates set to the new data, and
setting the selected metadata candidate to the new data as metadata in response to that any one of metadata candidates is selected from among the plurality of metadata candidates.

15. The non-transitory computer-readable recording medium according to claim 12, further comprising:
managing a second metatask that creates new metadata in association with a task for data to be processed on the basis of metadata set to new data obtained by executing the task on the data to be processed, and
in a case where new data is obtained by executing the task on a single or a plurality of pieces of data, executing the second metatask that is managed in association with the task and creates new metadata on the basis of metadata set to the new data, and
setting the new metadata to the single or the plurality of pieces of data.
